(19) United States
(12) Patent Application Publication
(10) Pub. No.: US 2007/0269123 A1
(43) Pub. Date: Nov. 22, 2007

(54) Method and apparatus for performing image enhancement in an image processing pipeline

(76) Inventors: Randall Don Briggs, Boise, ID (US); Douglas Gene Keithley, Boise, ID (US)

Correspondence Address: BRINKS HOFER GILSON & LIONE/MARVELL, P.O. BOX 10395, CHICAGO, IL, 60610, US

(21) Appl. No.: 11/434,709

(22) Filed: May 16, 2006

(51) Int. Cl. G06K 9/40; G06K 9/00

(52) U.S. Cl. 382/254; 382/167

(57) ABSTRACT

An image enhancement component of an image processing pipeline preferably uses a single lookup table (LUT) to convert M-bit Red (R), Green (G) and Blue (B) values into respective N-bit R, G and B values, where N is greater than M. Preferably, the N-bit values are determined based on the inverse of an algorithm performed upstream of the image enhancement component by an image correction component. The N-bit R, G and B values provide the image with an improved signal-to-noise ratio (SNR).

### TECHNICAL FIELD OF THE INVENTION

The invention relates to scanners, printers, copiers, and other types of image processing systems that process color information used to represent an image. More particularly, the invention relates to performing image enhancement in an image processing system.

### BACKGROUND OF THE INVENTION

Scanner, printers and copiers are all examples of image processing systems that process bit information representing colors in the image. The images are represented by pixels, each of which includes bits that represent the colors. For example, in some image processing systems (e.g., a scanner) each pixel is defined by 16 bits that represent the amount of Red color in the pixel, 16 bits that represent the amount of Green color in the pixel, and 16 bits that represent the amount of Blue in the pixel. Thus, each pixel is represented in these systems by 48 bits.

FIG. 1 illustrates a block diagram of a known scanner image processing system 2. The system 2 includes a scanning component 3 having a light source (not shown) that projects light onto the item being scanned (e.g., photograph) and a sensor component (not shown) comprising arrays of photodiodes or charge coupled devices (CCDs). The sensor elements sense the light reflected off of the item being scanned and convert the sensed light into electrical signals. The electrical signals are converted into respective digital values called pixels by an analog-to-digital converter (ADC) 4. Typically, the ADC 4 outputs 16 bits per color per pixel, resulting in each pixel being represented by a 48-bit value.

An image correction component 5 receives the pixel values from the ADC 4 and processes them on a color-by-color basis (e.g., Red, then Blue, then Green) in accordance with an image correction algorithm. The image correction algorithm compensates for non-uniformities among the sensors of the scanning component 3. These non-uniformities are commonly referred to as photo-response non-uniformities (PRNUs) and dark signal non-uniformities (DSNUs). The final stage of the image correction component 5 is a bit depth reduction stage (not shown) that reduces the data from 16 bits per color per pixel to 8 bits per color per pixel. This reduction may be as simple as dropping the lower 8 bits of each 16 bit per color pixel. The image correction component 5 outputs 24 bits per pixel, which corresponds to three 8-bit values that each represent the respective Red, Green and Blue (RGB) colors.

The data output from the image correction component 5 is then stored in a memory device 6 (e.g., dynamic random access memory (DRAM)). The purpose for the memory device 6 is to gather the R, G, B data so that it is all simultaneously available for processing in the subsequent stage in the image processing pipeline. This is needed because the spatial displacement of the sensors in the scanning component 13 results in the three color channels being processed at different points in time in the image correction component 5. The bit depth of the pixels is reduced prior to storing them in the memory device 6 to enable the size and associated cost of memory device 6 to be reduced.

The next component in the image processing pipeline is an image enhancement component 7, which enhances the image data. Because the image correction component 5 reduces the bit depth of each color component from 16 bits to 8 bits, the degree of improvement that can be achieved by the image enhancement component 7 is limited.

It would be advantageous to provide an image processing system with an image enhancement component that is capable of improving the degree of image enhancement that can be achieved by the image enhancement component of the image processing system. It would also be advantageous to provide an image enhancement component that is very efficient in terms of the amount of space it consumes on the IC, such as the amount of memory required for intermediate storage.

### SUMMARY OF THE INVENTION

The invention provides a method and an apparatus for performing image enhancement. The apparatus comprises an image enhancement component that receives a number, M, of bits per color of image data, converts the M bits per color of image data into N bits per color of image data, and outputs N bits per color of image data, where N is larger than M. The method comprises receiving M bits per color of image data, converting each of the M bits of image data into a respective N-bit value, and outputting the N-bit values.

These and other features and advantages of the invention will become apparent from the following description drawings and claims.

### BRIEF DESCRIPTION OF THE DRAWINGS

FIG. 1 illustrates a block diagram of a known scanner image processing system.

FIG. 2 illustrates a block diagram of an image processing system that implements the image enhancement apparatus and method of the invention in accordance with an exemplary embodiment.

FIG. 3 illustrates a block diagram of the image enhancement apparatus shown in FIG. 2.

FIG. 4 illustrates a state diagram that demonstrates the states of the image enhancement apparatus shown in FIG. 3.

FIG. 5 illustrates a flowchart that represents the method of the invention in accordance with an exemplary embodiment.

### DETAILED DESCRIPTION OF EXEMPLARY EMBODIMENTS

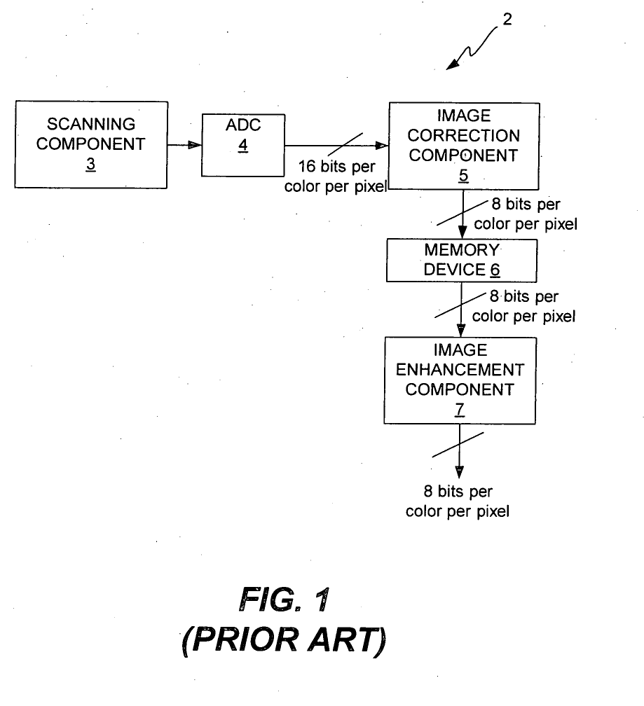

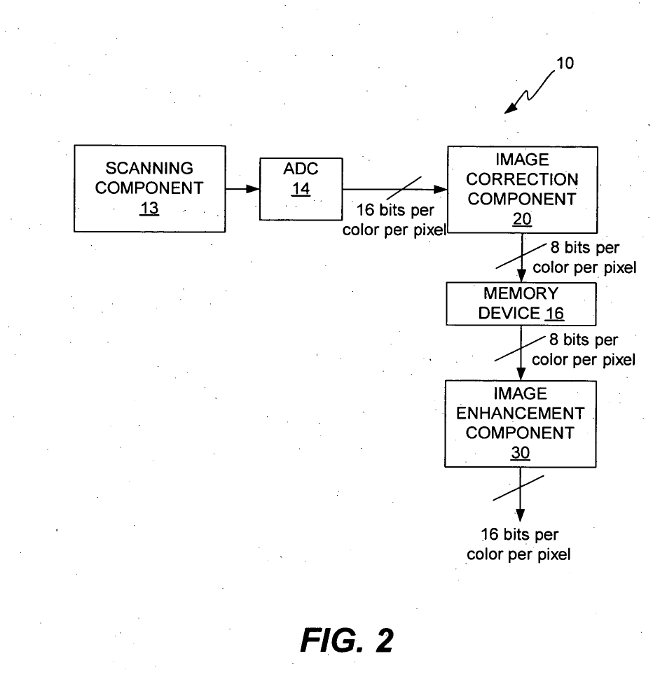

FIG. 2 illustrates a block diagram of an image processing system 10 that implements the image enhancement apparatus and method of the invention in accordance with an exemplary embodiment. The components 13, 14 and 16 of the image processing system 10 may be identical to or similar to the components 3, 4 and 6, respectively, shown in FIG. 1. Therefore, the functions performed by components 13, 14 and 16 of the image processing system 10 will not be described herein.

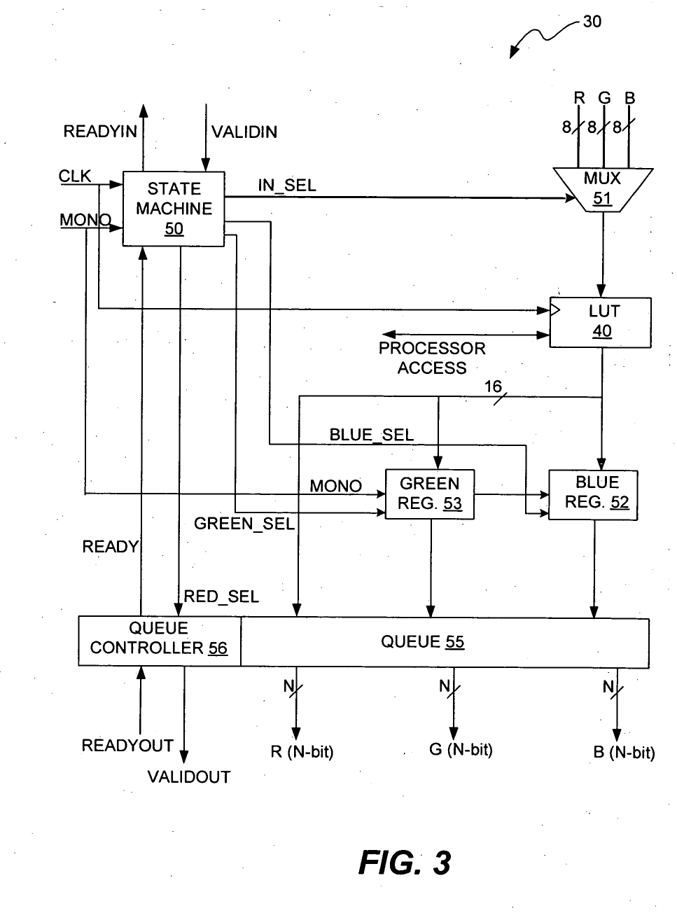

In accordance with the invention, the image correction component 20, in addition to the functions described above with reference to the known image correction component 5, processes the R, G, B color data in accordance with an algorithm that determines which of the 16 bits representing each color can be discarded without significantly decreasing the signal-to-noise ratio (SNR) of the image data. A LUT (not shown) may be used in the image correction component to convert the 16-bit values into 8-bit values. As described below with reference to FIG. 3, the image enhancement component 30 of the invention preferably implements a single LUT that contains preselected 16-bit values that are determined based on the inverse of the algorithm performed by the image correction component 20. Therefore, the image enhancement component 30 restores each of the R, G, B color components to 16-bit values that provide the image with an improved SNR. Utilizing 16 bits per pixel enables the image enhancement component 30 to provide improved image quality over the aforementioned known 8-bits-per-pixel solution.

FIG. 3 illustrates a block diagram of the image enhancement component 30 of the invention in accordance with an exemplary embodiment. In accordance with this exemplary embodiment, a single LUT 40 stores 16-bit values that are used to represent the R, G, B values. A state machine 50 controls the timing of the operations that are performed in the image enhancement component 30. As stated above, the values received by the LUT 40 are 8-bit values. However, it should be noted that the invention is not limited with respect to the number of bits that are received by the LUT 40 and/or that are output from the LUT 40. Although this embodiment shows 8 bits per color coming into the image enhancement component 30 and 16 bits per color being output from the image enhancement component 30, the invention is not limited to such a 1:2 aspect ratio. For example, the invention would equally apply to configurations that receive 8 bits per color and output 10 bits per color or 14 bits per color.

The image enhancement component 30 performs bit depth enhancement. In the image enhancement component 30, the data flows vertically from top to bottom. The incoming data is received from the prior stage in the pipeline, which is typically the memory device 16. The interfaces between the stages of the image processing pipeline use a “ready-ready” handshake. In other words, when both the sending side and the receiving side of the pipeline interfaces indicate that they are “ready”, data is transferred on the rising edge of the clock, CLK. The sending side ready signal is referred to herein as VALIDIN, which is one of the inputs to the state machine 50. The receiving side ready signal is referred to herein as READYIN, which is the output from the state machine 50 that is sent to the previous pipeline stage.

When both the READYIN and VALIDIN signals are asserted, 24 bits of data corresponding to a single pixel made up of an 8-bit R component, an 8-bit G component, and an 8-bit Blue component are transferred on the rising edges of CLK. The R, G, B data transferred from the previous stage is received by the multiplexer (MUX) 51. The state machine 50 outputs a multi-bit (e.g., 2-bit) address, IN_SEL, to the MUX 51 that causes the MUX 51 to select one of the R, G, B 8-bit components for processing by the LUT 40. The LUT 40 uses the selected 8-bit color value as an address of a location in the LUT 40 at which a corresponding 16-bit color value is stored. The LUT 40 may be, for example, a static RAM (SRAM) memory device that has been configured previously with the desired output values for the incoming color values. The LUT 40 may be made accessible to a processor for testing and/or configuring the LUT 40, as indicated by the input/output arrow labeled “PROCESSOR ACCESS”.

The LUT 40 is shared between all three colors, which are sequentially addressed and output, e.g., in a B, G, R sequence. When the R component is used by the LUT 40, the corresponding 16-bit result outputted from the LUT 40 is loaded in parallel into an output queue 55, which is typically a first-in-first-out (FIFO) memory device. The 16-bit B and G values are first saved in registers 52 and 53, respectively, until those values are ready to be loaded into the queue 55. There is no need to have a register for holding the R value because once the B and G values have been loaded into the registers 52 and 53 (i.e., after two clock cycles), all three values are ready (i.e., on the next clock cycle) to be loaded in parallel into the queue 55.

The registers 52 and 53 receive a BLUE_SEL signal and a GREEN_SEL signal, respectively, from the state machine 50. When these signals are asserted, the registers 52 and 53 capture their respective N-bit values and present the data to the queue 55. The queue 55 includes a queue controller 56 that controls the operations performed by the queue 55. The queue controller 56 outputs a READY signal to the state machine 50, which informs the state machine 50 as to when the queue 55 is ready to receive the next 48 bits of color data. The queue controller 56 outputs a VALIDOUT signal to the subsequent stage (not shown) of the image processing pipeline, which informs the subsequent stage as to when the results contained in the queue 55 are valid and are ready for processing by the subsequent stage. The subsequent processing stage (not shown) sends a READYOUT signal to the queue controller 56. When the RED_SEL signal received by the queue controller 56 is asserted and the READY signal received by the state machine 50 is asserted, the queue 55 loads the 16-bit Red, Green and Blue values into the queue 55. When the VALIDOUT and READYOUT signals are asserted, the data stored in the queue 55 is transferred from the queue 55 to the subsequent stage of the image processing pipeline.

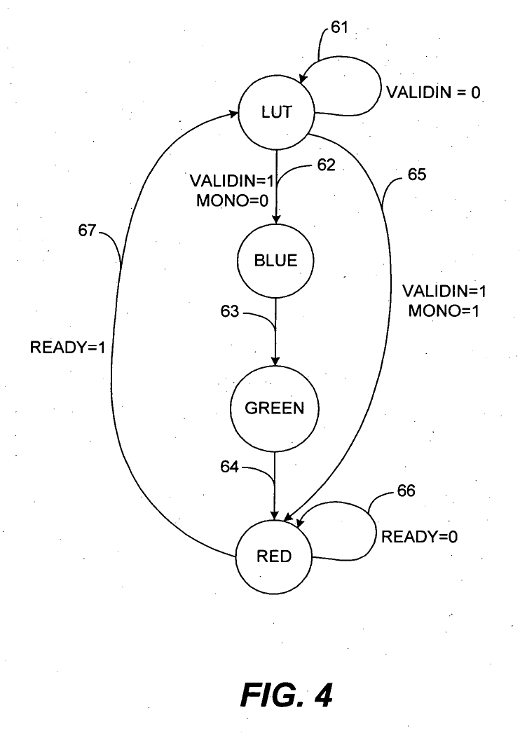

The image enhancement component 30 is also configured with an option to execute a monochromatic mode (MONO), during which only one of the R, G, B color components is used to represent the image. In the exemplary embodiment shown in FIG. 4, the R value is used during the MONO mode. In this mode, a MONO signal is received by the registers 52 and 53. When the MONO signal is asserted, registers 52 and 53 clear their contents so that a known value is presented to the queue 55. The RED_SEL signal received by the queue controller 56 is asserted whenever the 16-bit R value is ready to be transferred from the LUT 40 to the queue 56.

FIG. 4 illustrates a state diagram that demonstrates the states of the state machine 50 shown in FIG. 3. In this example, the LUT 40 is a clocked device that has the output data delayed by one clock cycle relative to the input data. In this example, the state machine 50 also uses the same clock, so the input data presented to the LUT 40 in one state generates the output data for the next state. For the LUT 40 output data based on the 8-bit G value to be present when the state machine 50 is in the Green state, the previous state (Blue) must have presented the 8-bit G value to the input of the LUT 40.

While the VALIDIN signal is low, the state machine 50 remains in a LUT state, as indicated by arrow 61. When VALIDIN is high and MONO is low, the IN_SEL address causes MUX 51 to select the 8-bit B value and present this 8-bit B value to the input of the LUT 40. When VALIDIN is high and MONO is low, the state machine enters the Blue state, as indicated by arrow 62. In the Blue state, the IN_SEL address causes the MUX 51 to select the 8-bit G value and present this 8-bit G value to the input of the LUT 40. The output of the LUT 40 is the 16-bit B value derived from the 8-bit B value that was presented to the input of the LUT 40 during the previous state. In the Blue state, the BLUE_SEL is asserted, causing the Blue register 52 to capture the corresponding 16-bit B value output from the LUT 40. The state machine 50 then enters the Green state, as indicated by arrow 63. In the Green state, the IN_SEL address causes the MUX 51 to select the 8-bit R value and present this 8-bit R value to the to the input of the LUT 40. The output of the LUT 40 is the 16-bit G value derived from the 8-bit G value that was presented to the input of the LUT 40 during the previous state. In the Green state, the GREEN_SEL is asserted, causing the Green register 53 to capture the corresponding 16-bit G value output from the LUT 40. The state machine 50 then enters the Red state, as indicated by arrow 64. In the Red state, the IN_SEL address causes the MUX 51 to select the 8-bit R value. The output of the LUT 40 is the 16-bit R value derived from the 8-bit R value that was presented to the input of the LUT 40 during the previous state. While in the Red state, the state machine 50 will remain in the Red state as long as the READY is low, as indicated by arrow 66. In the Red state, when the RED_SEL and the READY signals are asserted, the 16-bit R, G and B values are captured by the queue 55, as described above with reference to FIG. 3. The state machine then returns to the LUT state, as indicated by arrow 67.

As indicated by arrow 65, the state machine 50 may also enter the Red state if both the VALIDIN and MONO signals are high, which corresponds to the MONO mode described above with reference to FIG. 3. When the MONO signal is high, IN_SEL always selects the 8-bit R value presented to MUX 51 so that the corresponding 16-bit R value presented to the queue 55 is always based on the 8-bit R value.

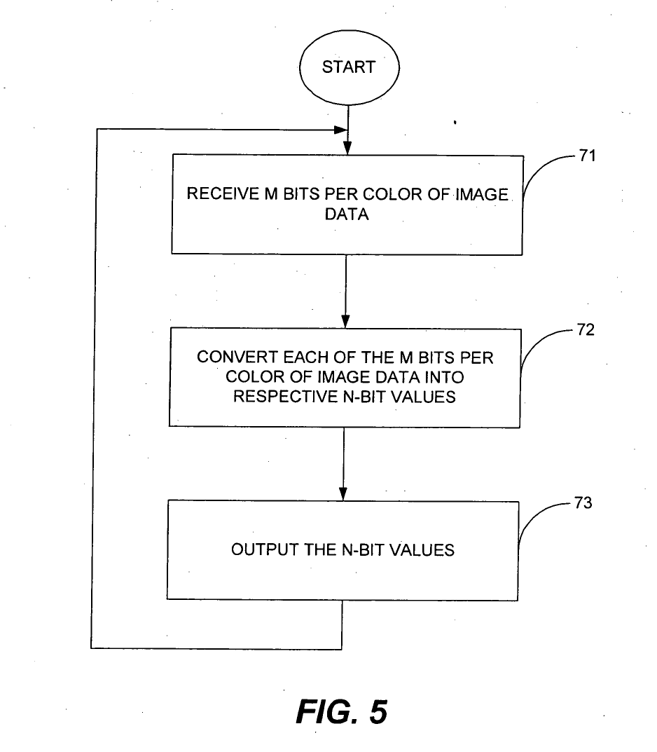

FIG. 5 illustrates a flowchart that represents the method of the invention in accordance with an exemplary embodiment. The image enhancement component receives M bits per color of image data, as indicated by block 71. For the configuration shown in FIG. 3, this step corresponds to receiving an 8-bit R component, an 8-bit G component and an 8-bit blue component. Each of the M-bit values is then converted into a respective N-bit value, as indicated by block 72. In the configuration shown in FIG. 3, this step corresponds to using the LUT 40 to convert the received 8-bit R, G, B values into respective 16-bit R, G, B values. The N-bit values are then output from the image enhancement component and sent to the subsequent processing stage, as indicated by block 73. In the configuration shown in FIG. 3, this step corresponds to outputting N-bit R, G, B values in parallel from the queue 55, unless operating in the Mono mode, in which case one of the N-bit values (e.g., the R value) is output from the queue 55.

It should be noted that the invention has been described with reference to preferred and exemplary embodiment and that the invention is not limited to these embodiments. For example, the invention is not limited to the configuration shown in FIG. 3, as will be understood by those skilled in the art. In addition, while the image enhancement apparatus of the invention shown in FIG. 3 has been described above as being implemented in hardware, it may be implemented in hardware, software, or a combination of hardware, software and/or firmware. Those skilled in the art will understand, in view of the description provided herein, the manner in which the embodiments described herein can be altered and that all such alterations are within the scope of the invention.

1. An apparatus for performing image enhancement, the apparatus comprising:
an image enhancement component, the image enhancement component receiving a number, M, of bits per color of image data, converting the M bits per color of image data into a number, N, bits per color of image data, and outputting the N bits per color of image data, wherein N is larger than M.

2. The apparatus of claim 1, wherein the image enhancement component receives M bits of Red (R) image data, M bits of Green (G) image data and M bits of Blue (B) image data and outputs N bits of R image data, N bits of G image data and N bits of B image data.

3. The apparatus of claim 2, wherein the image enhancement component includes:
a state machine configured to control a timing of events in the image enhancement component;
at least one lookup table (LUT) that stores a plurality of N-bit values at a plurality of respective addresses in the LUT, the LUT receiving M bits of image data during a processing cycle and using said M bits to access a corresponding N-bit value stored in the LUT, the LUT outputting the corresponding N-bit value;
timing logic configured to receive one or more signals from the state machine, the timing logic controlling a timing of providing said M bits of the R, G or B image data to the LUT; and
storage logic configured to store the N-bit values output from the LUT.

4. The apparatus of claim 3, wherein the timing logic includes multiplexing logic that sequentially selects one of the M bits of R, G and B image data to be provided to the LUT such that each of the respective M bits of R, G and B image data are provided to the LUT in successive processing cycles.

5. The apparatus of claim 3, wherein the storage logic comprises:
a first register for storing N bits of R, G or B image data output from the LUT during a first processing cycle;
a second register for storing N bits of R, G or B image data output from the LUT during a second processing cycle; and
a queue for storing N bits of R, G or B data output from the first register, N bits of R, G or B data output from the second register, and N bits of R, G, or B data output from the LUT during a third processing cycle.

6. The apparatus of claim 2, wherein the image enhancement component includes a monochromatic mode, and wherein if the image enhancement component is operating in the monochromatic mode, the N bits per color of image data output from the image enhancement component is based on only one of the R, G or B image data.

7. The apparatus of claim 1, wherein N is equal to 2×M.

8. The apparatus of claim 1, wherein the apparatus is incorporated into a scanner.

9. The apparatus of claim 1, wherein the apparatus is incorporated into a copier.

10. The apparatus of claim 1, wherein the apparatus is incorporated into a printer.

11. A method for performing image enhancement comprising:
receiving a number, M, of bits per color of image data;
converting each of the M bits of image data into a respective N-bit value, wherein N is greater than M; and
outputting the N-bit values.

12. The method of claim 11, wherein the receiving step includes receiving M bits of Red (R) image data, M bits of Green (G) image data and M bits of Blue (B) image data, and wherein the outputting step includes outputting N bit values of R image data, N bit values of G image data and N bit values of B image data.

13. The method of claim 12, wherein the converting step includes applying the M bits of R, G and B data to a lookup table (LUT) in a sequence such that the M bits of R, G, and B image data are applied to the LUT during different processing cycles.

14. The method of claim 13, wherein time division multiplexing is used by the converting step to cause the R, G and B image data to be applied to the LUT during the different processing cycles.

15. The method of claim 14, further comprising the step of:
prior to outputting the N-bit values, storing N bits of R image data, N bit of G image data and N bits of B image data in a queue, and wherein the outputting step outputs R, G and B N-bit values in parallel.

16. The method of claim 11, wherein N is equal to 2×M.

17. The method of claim 11, wherein the method is implemented in a scanner.

18. The method of claim 11, wherein the method is implemented in a copier.

19. The method of claim 11, wherein the method is implemented in a printer.

20. The method of claim 12, wherein the method is capable of being performed in monochromatic mode, wherein if the method is being performed in the monochromatic mode, the N-bit values output during the outputting step are based on only one of the R, G or B image data.

21. An image enhancement system comprising:
an input device adapted to receive color data for a plurality of colors, the received color data including a first number of bits per color;
a bit depth enhancement module adapted to convert the received color data to a larger second number of bits per color to create enhanced color data; and
an output device adapted to output the enhanced color data.

22. The image enhancement system of claim 21, wherein the bit depth enhancement module comprises a look-up table for mapping color values having the first number of bits to color values having the second number of bits.

23. The image enhancement system of claim 22, wherein the look-up table maps color values having the first number of bits to color values having the second number of bits based on an inverse algorithm of an image correction algorithm employed in an image correction module.

24. The image enhancement system of claim 22, wherein the look-up table maps color values having the first number of bits to color values having the second number of bits based on an inverse algorithm of a bit reduction algorithm employed by an image correction component.

25. The image enhancement system of claim 21, wherein the input device is adapted to separately provide, to the bit depth enhancement module, color values having the first number of bits for individual colors of the plurality of colors.

26. The image enhancement system of claim 21, wherein the output device comprises a first-in-first-out memory queue adapted to receive enhanced color values having the second number of bits for each of the plurality of colors corresponding to a particular image pixel, and outputting a single value including the enhanced color values of each of the plurality of colors.

27. The image enhancement system of claim 21, further comprising a state machine adapted to coordinate operation of the input device, the bit depth enhancement module, and the output device.

28. The image enhancement system of claim 27, wherein the input device comprises a multiplexer adapted to receive red, green and blue color values having the first number of bits per color, and adapted to output a color value corresponding to one of the colors red, green or blue based on a color select signal generated by the state machine.

29. The image enhancement system of claim 28, wherein the bit depth enhancement module comprises a look-up table for mapping the color values having the first number of bits output from the multiplexer to color values having the second number of bits.

30. The image enhancement system of claim 29, wherein the state machine is adapted to coordinate operation of the multiplexer and the look-up table to sequentially enhance red, green and blue color values.

31. The image enhancement system of claim 30, further comprising a first register for temporally storing color values corresponding to a first color and having the second number of bits, and a second register for storing color values corresponding to a second color and having the second number of bits.

32. The image enhancement system of claim 31, further comprising a color value data queue adapted to assemble enhanced red, green, and blue color values and transfer the enhanced red, green, and blue color values to a next stage of an image processor.

33. The image enhancement system of claim 32, wherein the color value data queue comprises a first-in first-out SRAM memory device.

34. The image enhancement system of claim 21, wherein the system is incorporated into an image scanner.

35. The image enhancement system of claim 21, wherein the system is incorporated into an image copier.

36. The image enhancement system of claim 21, wherein the system is incorporated into an image printer.

37. An image enhancement system comprising:
an input means for receiving color data for a plurality of colors, the received color data including a first number of bits per color;
a bit depth enhancement means for converting the received color data to a larger second number of bits per color to create enhanced color data; and
an output means for outputting the enhanced color data.

38. The image enhancement system of claim 37, wherein the bit depth enhancement means comprises mapping means for mapping color values having the first number of bits to color values having the second number of bits.

39. The image enhancement system of claim 38, wherein the mapping means comprises a look-up table storing color values wherein color values having the first number of bits are mapped to color values having the second number of bits based on an inverse algorithm of a bit reduction algorithm employed by an image correction component.

40. The image enhancement system of claim 37, wherein the input means is adapted to separately provide, to the bit depth enhancement means, color values having the first number of bits for each color.

41. The image enhancement system of claim 37, wherein the output means comprises a first-in-first-out memory queue adapted to receive enhanced color values corresponding to a particular image pixel having the second number of bits for the plurality of colors and provide a single output value including the enhanced color values of the plurality of colors.

42. The image enhancement system of claim 37, further comprising control means for coordinating operation of the input means, the bit depth enhancement means, and the output means.

43. The image enhancement system of claim 42, wherein the input means comprises a multiplexer adapted to receive red, green and blue color values, each having the first number of bits per color, and output a color value corresponding to one of the colors red, green or blue based on a color select signal generated by the control means.

44. The image enhancement system of claim 43, wherein the bit depth enhancement means comprises a look-up table for mapping the color values having the first number of bits output from the multiplexer to color values having the second number of bits.

45. The image enhancement system of claim 44, wherein the look-up table maps color values having the first number of bits to color values having the second number of bits based on an inverse algorithm of an image correction algorithm employed in an image correction module.

46. The image enhancement system of claim 44, wherein the control means is adapted to coordinate operation of the multiplexer and the look-up table to sequentially enhance red, green and blue color values.

47. The image enhancement system of claim 46, further comprising first register means for temporally storing color values corresponding to a first color and having the second number of bits, and second register means for storing color values corresponding to a second color and having the second number of bits.

48. The image enhancement system of claim 47, further comprising a color value data queue means for assembling enhanced red, green, and blue color values and transferring the enhanced red, green, and blue values to a next stage of an image processor.

49. The image enhancement system of claim 48, wherein the color value data queue means comprises a first-in first-out SRAM memory device.

50. The image enhancement system of claim 37, wherein the system is incorporated into an image scanner.

51. The image enhancement system of claim 37, wherein the system is incorporated into an image copier.

52. The image enhancement system of claim 37, wherein the system is incorporated into an image printer.

53. A method of enhancing an image, the method comprising:
receiving a first color value having a first number of bits; and
converting the first color value to a second color value having a second number of bits, the second number of bits being greater than the first number of bits.

54. The method of claim 53, wherein receiving a first color value comprises receiving first color values for a plurality of colors, and wherein converting a first color value to a second color value comprises converting a first color value to a second color value for each of the plurality of colors.

55. The method of claim 54, wherein the plurality of colors comprises the colors red, green, and blue.

56. The method of claim 53, further comprising creating a look-up table mapping a plurality of color values having the first number of bits to a plurality of color values having the second number of bits.

57. The method of claim 56, wherein converting the first color value to the second color value comprises accessing the look-up table based on the first color value and retrieving the second color value to which the first color value is mapped.

58. The method of claim 56, wherein creating a look-up table comprises mapping the plurality of color values having the first number of bits to the plurality of color values having the second number of bits based on an inverse algorithm of an image correction algorithm employed in an image correction process.

59. The method of claim 56, wherein receiving a first color value having a first number of bits comprises receiving a first color value having a red component value, a green component value, and a blue component value, each component value having a first component number of bits, and converting the first color value to the second color value comprises converting each component value from a first component value having the first component number of bits to a second component values having a second component number of bits.
